(19) United States
(12) Patent Application Publication
(10) Pub. No.: US 2016/0048138 A1
(43) Pub. Date: Feb. 18, 2016

(54) Compact Inverted Pressure Regulator for Dispensing a Gas

(71) Applicant: AD-VENTA, BOURG DE PEAGE (FR)

(72) Inventor: Jean-Luc Mussot, Loriol Sur Drome (FR)

(21) Appl. No.: 14/779,462

(22) PCT Filed: Mar. 24, 2012
(86) PCT No.: PCT/FR2014/000062

§ 371 Date: Sep. 23, 2015

(30) Foreign Application Priority Data
Mar. 25, 2013 (FR) FR13/00681

(51) Int. Cl. G05D 16/10

(52) U.S. Cl. CPC G05D 16/103

(57) ABSTRACT

An inverted gas pressure regulator includes at least one inlet duct for admitting a gas at a high pressure, at least one outlet duct for letting out this gas at a low pressure from a downstream expansion chamber. A mobile regulator piece against one side of which the low pressure presses and against the other side of which a spring element presses that is able to close off the high pressure gas inlet. Upstream and downstream connectors are able to connect and incorporate the pressure regulator to/into any gas circuit. Inlet and outlet ducts are each situated in the upstream and downstream connectors respectively, and these two connectors, which are positioned coaxially, are able to connect the pressure regulator in-line to said circuit.

The subject matter of the present invention is a compact inverted pressure regulator for the distribution of gas.

The technical sector of the invention is the field of the manufacture and use of pressurized gas regulator devices in which the delivery of the gas expanded to a particular pressure is independent of the pressure of the gas at the inlet.

In order to expand a gas from a so-called high first pressure level to a so-called low second pressure level lower than the high pressure, it is in fact known to use pressure regulation devices known simply as pressure regulators.

The operating principle of a pressure regulator is perfectly understood: it is based on two equal forces exerted directly or indirectly on respective opposite sides of a mobile regulation part, such as a diaphragm or a piston, on the one hand by the gas at the high pressure and at the low pressure and on the other hand by an element with a spring effect; in the commonest situation where the reference force of the spring element is exerted on the side opposite that exerted at the same time by the gas at the low pressure and the gas at the high pressure, these two gases fill two chambers separated by a partition including a duct in which slides a rod fastened to the mobile regulation part and including a valve adapted to shut off this duct in the direction from the high-pressure chamber to the low-pressure chamber when the force transmitted at the same time by the gas at the low pressure and the gas at the high pressure is lower than the antagonistic force exerted by the spring, the latter pushes the mobile regulation part, the valve of which, situated on its rod, then opens the high-pressure gas inlet: the latter will then feed the chamber at the low pressure until the latter pressure, increasing, makes it possible to exert a force on the mobile regulation part equal to and subsequently greater than the antagonistic force of the spring element; this greater force will push the mobile regulation part until the high-pressure gas inlet is shut off, and so on; the equilibrium of said forces therefore ensures a virtually constant required low pressure for a particular value of the thrust of the spring element, which may be adjustable.

The expression inverted pressure regulator refers to a pressure regulator in which the spring element exerts a force on the mobile regulation part in the opposite direction to that of the commonest situation described above, namely on the same side as the force exerted by the gas at the high pressure, the area in contact with the gas at the high pressure then being less than the area in contact with the gas at the low pressure. Said so-called areas in contact are defined as being the actual areas over which the pressure concerned is applied to the mobile regulation part in the direction of its movement.

Additionally, in most known pressure regulators, whether inverted or not, if the high pressure of the gas to be expanded varies greatly, the corresponding force on the mobile regulation part will change and the valve will no longer open at the same time, leading to a variation of the low pressure of the gas expanded through this valve and therefore poor operation and efficiency, together with disturbances in the user device, which is situated on the downstream side of the pressure regulator, from which it directly receives the gas at the low pressure.

Each pressure regulator therefore has a “dynamic expansion curve” that represents this property, which can therefore be a great nuisance. To alleviate this drawback, several known pressure regulator categories have been developed that adjust the outlet pressure independently of the inlet pressure when the latter can vary, such as:
those with two stages,
those, of classic type, having a so-called “compensated” valve that eliminates the influence of the high pressure, and
those, of inverted type, having a very small effective contact area on the high-pressure gas side so that the latter pressure, applied over a small area, generates a force on the mobile regulation part that is negligible compared to that exerted by the spring element which bears on it in the same direction, while the contact area on the low-pressure gas side is large, as described in patent applications EP362166, FR2879721 and FR2050407; moreover, in the shut off position, the high-pressure gas does not act directly on the mobile regulation element, as in the embodiments described below, because it acts perpendicularly to the axis along which the member allowing the gas to feed the chamber at the low pressure opens: in this position the effective contact area on the high-pressure gas side, perpendicular to the mobile regulation part, and which is the only one acting, therefore even becomes extremely low, if not zero.

The present invention is situated in this latter category of gas pressure regulators and relates to a compact pressure regulator designed to be mounted simply and quickly, requiring a minimum number of connectors, on any type of gas inlet duct most directly connecting a source of gas at high pressure to a user device operating at a low pressure, or directly between the source and the user device, and the low outlet pressure whereof can be easily adjustable.

This objective is achieved by an inverted gas pressure regulator including at least one so-called high-pressure gas inlet duct, at least one so-called low-pressure gas outlet duct leading from a downstream expansion chamber, a mobile regulation part on one side of which the low pressure is exerted and on the other side of which a spring element bears, and which is adapted to shut off the high-pressure gas inlet, and an upstream connector and a downstream connector adapted to connect the pressure regulator to and integrate it into any gas circuit supplying, on its upstream side, the high-pressure gas and, on the downstream side of the pressure regulator, said low-pressure gas, and such that, in accordance with the invention, said inlet duct and said outlet duct are situated in and discharge into the upstream connector and the downstream connector, respectively, and these two connectors, disposed coaxially, are adapted to connect the pressure regulator in line to said circuit.

Moreover, the pressure regulator includes a device for adjusting the thrust of the spring element in the position with the high-pressure gas inlet shut off, which adjustment device is coaxial with the movement of the mobile regulation part and can be modified by rotation of an axial element of at least one of the connectors.

The result is a new inverted gas pressure regulator that addresses the above objectives because, among other things, it can be connected in line in any circuit or directly on one side to the high-pressure gas source and on the other to the low-pressure user device, the whole then forming a compact device with no intermediate connectors that is transportable and mobile and in which it is simple to adjust the low pressure.

Other advantages of the present invention could be cited but those cited above already demonstrate sufficient advantages to prove its novelty and benefit.

The following description and the appended drawings represent two embodiments of the invention, but are not limiting on the invention: other embodiments are possible within the spirit and scope of this invention.

In fact, although the invention is described in connection with particular embodiments, it is obvious that it is in no way limited to them but to the contrary is open to modifications and variants that will be apparent to the person skilled in the art and that it comprises all the technical elements of the means described and combinations thereof within the scope of the invention.

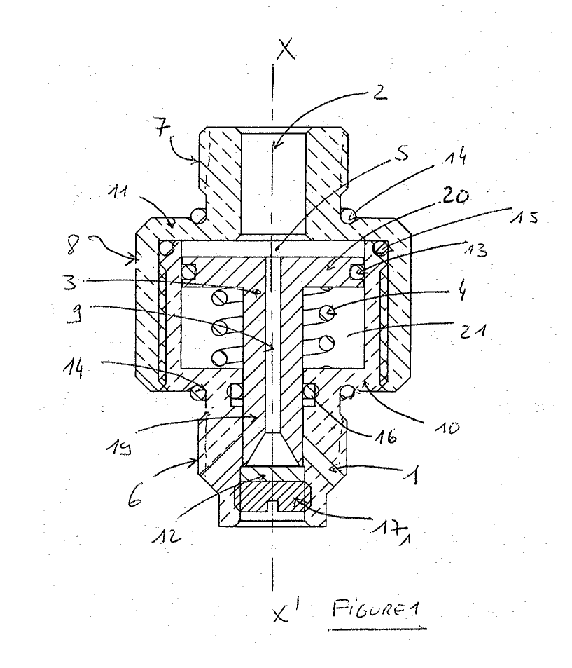

FIG. 1 is a view in axial section of a pressure regulator in accordance with the invention with adjustment of the low pressure on the side of the high-pressure gas inlet connector.

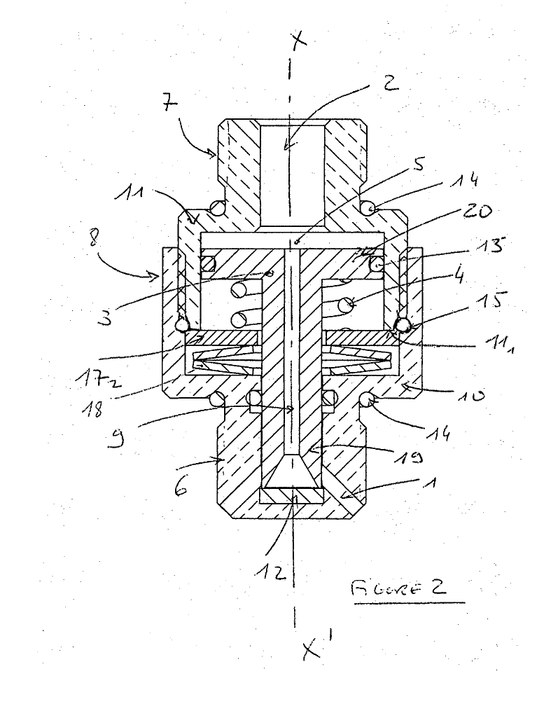

FIG. 2 is a view in axial section of a pressure regulator in accordance with the invention with adjustment of the low pressure on the side of the low-pressure gas outlet connector.

The pressure regulator in accordance with the invention comprises a substantially tubular hollow body 8 with axis XX′ made from a gas-tight material compatible with the gases; in known manner it includes at least:
a so-called high-pressure gas inlet duct 1,
a so-called low-pressure gas outlet duct 2 leading from a downstream expansion chamber 5,
a mobile regulation part 3 on which bear on one side the low pressure and on the other side a spring element 4 and which is adapted to shut off the high-pressure gas inlet 1, and
an upstream connector 6 and a downstream connector 7 adapted to connect the pressure regulator to and integrate it into any gas circuit supplying the high-pressure gas to the latter regulator on the upstream side and feeding said gas at the low pressure from the downstream side of the pressure regulator.

In accordance with the invention, said gas inlet duct 1 and said gas outlet duct 2 are situated in and discharge into the upstream connector 6 and the downstream connector 7, respectively, and these two connectors 6,7, disposed coaxially along the axis XX′, are adapted to connect the pressure regulator in line to said circuit, along this axis, for example on one side directly to the high-pressure gas source, which may be a small gas storage reservoir, such as a removable hydrogen refill based on metal hydrides, and on the other to the low-pressure user device, which may be a small electrical generator utilizing the energy of the gas, such as a small fuel cell, the whole then forming a compact device with no intermediate connectors that is transportable and mobile.

The hollow body 8 of this pressure regulator preferably consists of two coaxial hollow parts, of cylindrical shape, preferably of circular cylindrical shape, one part 10 referred to as the upstream part on the high-pressure side and the other, downstream part 11 on the low-pressure side, nested in and screwed into one another and forming an internal volume in which the mobile regulation part 3 moves. This hollow body 8 may also integrate various other components such as safety valves, safety immobilizing systems, connection devices other than the connectors, etc.

O-rings 14 are disposed on either side of the hollow body 8, on the side of the upstream connector 6 and the downstream connector 7 and respectively on the downstream side of the inlet duct 1 and the upstream side of the outlet duct 2, so as to seal the pressure regulator to the circuit to which it is assembled by connecting parts that screw or clip onto the connectors 6, 7.

The mobile regulation part 3, which may be a piston as shown in the figures but could be a diaphragm, includes:
an axial rod 19 of smaller section than the head to which it is fastened and that slides in a gas-tight manner in the bottom of the upstream part 10, and
a head 20 delimiting in the hollow part farthest inside the hollow body 8, which may be either the upstream part 10 as shown in FIG. 2 or the downstream part 11 as shown in FIG. 1, the variable volume and gas-tight expansion chamber 5, into which opens the outlet duct 2 which then crosses the interior of the downstream connector 7, for example axially as represented in the figures; in the FIG. 1 embodiment, the gas-tightness of the expansion chamber 5 necessitates a seal 15 such as the O-ring represented between the peripheral edge of the upstream hollow part 10 and the bottom of the downstream hollow part 11.

The gas-tightness of the piston 3, 20 between the expansion chamber 5 and the compartment 21 in which the spring element 4 is situated is provided by an O-ring 13 situated peripherally within the thickness of the head 20.

This compartment 21 preferably communicates with the outside of the pressure regulator, either by virtue of natural leakage via the screw connection between the upstream part 10 and the downstream part 11, as in FIG. 2, or via a duct that is not shown, as could be the case in FIG. 1, if it is required not to add a disturbing compression force against the head 20 of the piston, although this compartment 21 may to the contrary be rendered gas-tight and pressurized to a given value to obtain an effect forming a spring element to replace the spring 4 represented in the FIGS. 1 and 2 examples.

In the position with the high-pressure gas inlet 1 shut off, the distal end of the rod 19 comes to bear against a seal 12 forming an abutment and the spring element 4 surrounding the rod 19 bearing on one side against the head 20 of the piston 3 and on the other side against the bottom of the upstream hollow part 10 through which the rod 19 slides.

The high-pressure gas inlet duct 1 is situated in and discharges at one of its end into the interior, on the side of the upstream connector 6 and upstream of its fixing system, such as a screw fixing system, through the peripheral wall of which it passes, and, in the position with the high-pressure gas inlet 1 shut off as represented in the figures, discharges laterally at its other end against the distal end of the rod 19 of the mobile regulation part 3 that performs said shutting off.

In other embodiments not shown here, this duct 1 could be disposed on the axis XX′ of the pressure regulator, such as through or alongside the plug 17₁ represented in FIG. 1.

The high-pressure gas inlet 1 is opened when the low pressure in the expansion chamber 5 falls and the thrust of the spring 4 moves the mobile regulation part 3: the distal end of the rod 19 is then lifted off the abutment seal 12, opening the gas inlet 1, and here the communication between the latter and the expansion chamber 5 at the low pressure is provided by way of an internal channel 9 of the rod 19 of the mobile regulation part 3 open at both its ends.

In other embodiments, this communication may be provided by a duct external to the rod 20.

This pressure regulator in accordance with the invention preferably includes a device 17 for adjusting the thrust of the spring element 4 that is coaxial with the movement of the mobile regulation part 3 along the axis XX′ of the pressure regulator and the position of which along this axis, which can be modified by rotation of an axial element cooperating with one of the connectors 6, 7, determines the maximum compression force of the spring element 4 in the position with the high-pressure gas inlet 1 shut off, and therefore the value of the low pressure in the expansion chamber 5 that exerts the force antagonistic to that of this spring.

In accordance with the FIG. 1 embodiment, this adjustment device 17 is a plug 17₁ screwed along the axis of the upstream connector 6 into the interior of the bore pierced in the bottom of the upstream part 10 of the pressure regulator and in which the rod 19 of the piston 3 slides: by screwing the plug 17₁ in or out, this plug holds the abutment seal 12 at the required height so that, in the position with the high-pressure gas inlet 1 shut off, the maximum compression of the spring 4 corresponds to the force making it possible to obtain the required low pressure in the chamber 5.

In accordance with the FIG. 2 embodiment, the adjustment device 17 is a part 17₂ on which the spring 4 bears: this part 17₂ is a rigid disk pierced at its centre to allow the rod 19 free passage and forms a double bottom in the upstream hollow part 10 of the pressure regulator; a second spring element 18 situated inside this double bottom and of much greater stiffness and force than the regulation spring 4 holds this bearing part 17₂ against the peripheral edge 11₁ of the downstream hollow part 11 of the hollow body 8; in this embodiment, said downstream hollow part 11 is necessarily nested in and screwed into the upstream hollow part 10, but this nesting of the downstream part 11 in the upstream part 10 could also be used in the FIG. 1 embodiment whereas the nesting is reversed here.

In the position with the high-pressure gas inlet 1 shut off, screwing in or out this downstream hollow part 11, and therefore also the downstream connector 7 that is fastened to it so as to constitute a single part with it, varies the maximum compression of the spring 4 until it corresponds to the force making it possible to obtain the required low pressure in the chamber 5.

1.-7. (canceled)

8. An inverted gas pressure regulator comprising:
at least one high-pressure gas inlet duct,
at least one low-pressure gas outlet duct leading from a downstream expansion chamber;
a mobile regulation part having a first side where the low pressure is exerted and a second side where a spring bears and which is adapted to shut off the high-pressure gas inlet;
an upstream connector; and
a downstream connector adapted to connect the pressure regulator to and integrate it into a gas circuit supplying, on its upstream side, the high-pressure gas and, on the downstream side of the pressure regulator, the low-pressure gas;
wherein the duct and the outlet duct are situated in and discharge into the upstream connector and the downstream connector, respectively, and the upstream and downstream connectors are disposed coaxially and are adapted to connect the pressure regulator in line to the circuit.

9. The inverted gas pressure regulator of claim 8, further comprising:
a hollow body having an upstream hollow part and a downstream hollow part, wherein the hollow parts are coaxial with one nested in the other;
the mobile regulation part includes a head and a rod extending from one side of the head, wherein the other side of the head defines a variable-volume gas-tight expansion chamber and the rod slides in a gas-tight manner in a bottom portion of the upstream hollow part, wherein the rod includes a distal end configured to bear against an abutment seal when in a position with the high-pressure gas inlet shut off and the spring element surrounds the rod having a first end bearing on the one side against the head of the piston and having a second end bearing against the upstream hollow part adjacent the bottom portion of the upstream hollow part through which the rod slides.

10. The inverted gas pressure regulator of claim 8, further comprising an adjustment device configured to adjust the thrust of the spring element, wherein the adjustment device is coaxial with the movement of the mobile regulation part and its position, which can be modified by rotation of an axial element cooperating with one of the connectors, determines the maximum force of compression of the spring element when in the position with the high-pressure gas inlet shut off and therefore defines the value of the low pressure.

11. The inverted gas pressure regulator of claim 10, wherein the adjustment device is a plug screwed along the axis of the upstream connector into a bore pierced in the bottom of the upstream part and in which the rod of the piston slides, such that the plug adjustably holds the abutment seal at a selected height.

12. The inverted gas pressure regulator of claim 10, wherein the adjustment device is a bearing part forming a double bottom of the upstream hollow part and the regulator further comprises a second spring situated in the double bottom to hold the bearing part against an edge of the downstream hollow part of the hollow body, which is nested into the upstream hollow part, and a depth of nesting holds the bearing part at a selected height.

13. The inverted gas pressure regulator of claim 8, wherein the high-pressure gas inlet duct is disposed on a same side as the upstream connector and, when in the position with the high-pressure gas inlet shut off, discharges laterally against the distal end of the rod of the mobile regulation part that performs the shutting off.

14. The inverted gas pressure regulator of claim 8, wherein the rod of the mobile regulation part includes an internal channel open at both ends to provide communication between the high-pressure gas inlet and the low-pressure expansion chamber.
